(19) United States
(12) Patent Application Publication
(10) Pub. No.: US 2023/0341027 A1
(43) Pub. Date: Oct. 26, 2023

(54) TRANSMISSION UNIT, VEHICLE POWERTRAIN AND VEHICLE

(71) Applicants: Scania CV AB, Södertälje (SE); MAN Truck & Bus SE, Munich (DE)

(72) Inventors: Stefan KARLSSON, Stallarholmen (SE); Jörgen FORSBERG, Mariefred (SE); Tomas LÖFWALL, Årsta (SE); Per ARNELÖF, Vendelsö (SE); Tobias MÜLLER, Munich (DE)

(21) Appl. No.: 18/005,067

(22) PCT Filed: Jul. 27, 2021
(86) PCT No.: PCT/EP2021/070923

§ 371 Date: Jan. 11, 2023

(30) Foreign Application Priority Data
Jul. 29, 2020 (SE) 2050925-3

(51) Int. Cl. F16H 3/093; B60K 17/08; B60K 17/02; B60K 1/00

(52) U.S. Cl. CPC F16H 3/093; B60K 17/08; B60K 17/02; B60K 1/00; F16H 2200/0021; F16H 2200/0034; F16H 2200/0039; B60K 2007/0069

(57) ABSTRACT

A transmission unit, a vehicle powertrain and a vehicle are provided. The transmission unit comprises a first transmission shaft forming an input shaft of the transmission unit, and a second transmission shaft comprising a first shaft portion and a second shaft portion. The first shaft portion is rotatably connected to the first transmission shaft via a first gear wheel pair. The transmission unit further comprises a third transmission shaft rotatably connectable to the first shaft portion via a second gear wheel pair and rotatably connectable to the second shaft portion via a third gear wheel pair. The second and third gear wheel pairs are arranged at a distance from each other in a direction parallel to the longitudinal axis of the second transmission shaft such that, when the transmission unit is arranged in the vehicle powertrain, an electrical machine may be arranged therebetween.

### TECHNICAL FIELD

The present disclosure relates in general to a transmission unit for a vehicle powertrain. The present disclosure further relates in general to a vehicle powertrain, and to a vehicle.

### BACKGROUND

There is an ongoing strive today for development of electrically driven commercial vehicles, for example for environmental reasons. An electrically driven vehicle may have a vehicle powertrain of different configurations. For example, the vehicle powertrain may have a central drive configuration wherein the electrical machine is connected via a transmission unit and a propeller shaft to the drive shaft and driving wheels in a manner similar to the configuration of a conventional powertrain wherein the propulsion unit is a combustion engine. Vehicle powertrains wherein the electrical machine directly or indirectly drives the drive shaft, without any intermediate propeller shaft, are also known. The electrical machine and a transmission unit may for example be arranged on the drive shaft. Such powertrains have an electric axle configuration. In order to enable an electric axle configuration, it is important to reduce the size of the transmission and the electrical machine, since the available space for accommodating these components is limited.

Vehicle manufacturers are today faced with the problem of meeting a large variety of end user requirements for the vehicles produced. Modularization is a strategy that may be used to improve the ability of a vehicle manufacturer to efficiently provide end users, i.e. costumers, with a high variety of customized products. The modularization concept aims at providing the highest possible customer variety in the products with minimal number of items, given defined customer applications.

### SUMMARY

The object of the present invention is to provide a modular transmission unit, for an electric vehicle powertrain, that may be adapted to various end user requirements.

The object is achieved by means of the subject-matter of the appended independent claim(s).

In accordance with the present disclosure, a transmission unit for a vehicle powertrain is provided. The transmission unit comprises a first shaft forming an input shaft of the transmission unit. The transmission unit further comprises a second transmission shaft comprising a first shaft portion and a second shaft portion. The first shaft portion is rotatably connected to the first transmission shaft via a first gear wheel pair. The transmission unit further comprises a first coupling device configured to selectively couple the first shaft portion of the second transmission shaft to the second shaft portion of the second transmission shaft. The transmission unit also comprises a third transmission shaft rotatably connectable to the first shaft portion of the second transmission shaft via a second gear wheel pair and rotatably connectable to the second shaft portion of the second transmission shaft via a third gear wheel pair. The second gear wheel pair and the third gear wheel pair are arranged at a distance from each other in a direction parallel to the longitudinal axis of the second transmission shaft such that, when the transmission unit is arranged in the vehicle powertrain, an electrical machine connected to the first transmission shaft may be arranged between the second gear wheel pair and the third gear wheel pair.

The transmission unit according to the present disclosure can be used both for central drive configurations and electric axle configurations since it is configured so as to fit the available design space for both central axis and electric axle usage. This is among other things achieved by designing the transmission unit in consideration of the form factor of an electrical machine. At the same time, the transmission unit can be adapted to fit the requirements of an end user, such as requirements regarding number of gears and gear steps, due to the configuration thereof. The transmission unit also reduces the number of constituent components needed for adapting the transmission unit to end user requirements. In other words, the main components can be shared between central drive and electric axle configurations leading to an increased possibility for standardization of the constituent components. Thus, by means of the present transmission unit, a modular transmission unit and thus a modular powertrain platform dedicated for fully electric vehicles are enabled.

More specifically, in view of the second gear wheel pair and the third gear wheel pair being arranged at a distance from each other such that an electrical machine, used for propulsion, may be arranged between the second gear wheel pair and the third gear wheel pair, it is possible to arrange the electrical machine closer to the vehicle center (i.e. the longitudinal center of the vehicle). This may also enable more available space for accommodating energy storage devices configured to store energy for propulsion of the vehicle. Furthermore, the arrangement of the second gear wheel pair and the third gear wheel pair provides a space therebetween, alongside an electrical machine connected to the transmission unit. Said space may be utilized for other constituent components desired for adapting the transmission unit to end user requirements.

The first coupling device may be arranged at a position along the longitudinal axis of the second transmission shaft such that, when the transmission unit is arranged in the vehicle powertrain, the first coupling device is located in a first plane perpendicular to, and intersecting, a longitudinal extension of an electrical machine connected to the first transmission shaft. Thereby, a more compact design of the transmission unit may be achieved in view of utilizing the space in the transmission unit which, when arranged in the vehicle powertrain, will be present alongside the electrical machine (i.e. radially outside of the electrical machine).

The first coupling device may further be configured to selectively couple the third gear wheel pair to the second shaft portion of the second transmission shaft. Thereby, there is no need for a separate coupling device to selectively couple the third gear wheel pair to the second shaft portion of the transmission shaft. This in turn reduces the number of constituent components of the transmission unit. Moreover, it may reduce the space needed in the transmission unit for accommodating coupling devices needed for effectuating desired gear changes.

The transmission unit may further comprise a fourth gear wheel pair. The third transmission shaft may be rotatably connectable to the first shaft portion of the second transmission shaft via said fourth gear wheel pair. Thereby, the number of gear steps may be increased, thereby arriving at a so called 3-speed transmission unit.

The fourth gear wheel pair may be arranged at a position along the longitudinal axis of the second transmission shaft such that, when the transmission unit is arranged in the vehicle powertrain, the fourth gear wheel pair is located in a second plane perpendicular to, and intersecting, a longitudinal extension of an electrical machine connected to the first transmission shaft. Thereby, the space available in the transmission unit, alongside an electrical machine connected to the first transmission shaft, may be used for accommodating the fourth gear wheel pair. This is turn enables a more compact design of the transmission unit.

The transmission unit may further comprise a second coupling device configured to selectively couple the second gear wheel pair to the third transmission shaft. Thereby, the transmission unit may for example be adapted for utilization in a vehicle powertrain having an electrical axle configuration and/or enabling adapting the transmission unit to a 3-speed transmission unit. By arranging the second coupling device so as to be configured to selectively couple the second gear wheel pair to the third transmission shaft, the number of possible modifications of the transmission unit to meet end user requirements is increased. Furthermore, the space in the transmission unit for accommodating constituent components may be effectively utilized, thereby enabling a more compact design of the transmission unit.

The transmission unit may further comprise a fifth gear wheel pair configured to rotatably connect the second shaft portion of the second transmission shaft to a drive shaft of the vehicle powertrain, via a differential gear of the drive shaft, when the transmission unit is arranged in the vehicle powertrain. Thereby, the transmission unit may be utilized in a vehicle powertrain having an electric axle configuration.

The fifth gear wheel pair may be arranged between the second gear wheel pair and the third gear wheel pair. Thereby, the available space between the second gear wheel pair and the third gear wheel pair may be efficiently used leading to a compact design of the transmission unit. The fifth gear wheel pair, providing the connection to the drive shaft, may thus be arranged in the space available alongside the electrical machine when the transmission unit is arranged in the vehicle powertrain. This also enables arranging the electrical machine closer to a vehicle center (i.e. longitudinal center), if desired.

Furthermore, in accordance with the present disclosure, a vehicle powertrain is provided. The vehicle powertrain comprises a transmission unit and an electrical machine connected to an input shaft of the transmission unit. The transmission unit of the vehicle powertrain comprises a first transmission shaft forming the input shaft of the transmission unit. The transmission unit further comprises a second transmission shaft comprising a first shaft portion and a second shaft portion. The first shaft portion is rotatably connected to the first transmission shaft via a first gear wheel pair. The transmission unit further comprises a first coupling device configured to selectively couple the first shaft portion of the second transmission shaft to the second shaft portion of the second transmission shaft. The transmission unit also comprises a third transmission shaft rotatably connectable to the first shaft portion of the second transmission shaft via a second gear wheel pair and rotatably connectable to the second shaft portion of the second transmission shaft via a third gear wheel pair. The electrical machine is arranged parallel to a longitudinal extension of the second transmission shaft. Moreover, the second gear wheel pair and the third gear wheel pair are arranged on opposite sides of the electrical machine as seen in a direction parallel to a longitudinal axis of the second transmission shaft.

The vehicle powertrain can have either a central drive configuration or an electric axle configuration. This is a result of the transmission unit of the vehicle powertrain having a configuration adapted to fit the available design space for both vehicle powertrain configurations. More specifically, by means of the second gear wheel pair and the third gear wheel pair being arranged on opposite sides of the electrical machine as seen in a direction parallel to a longitudinal axis of the second transmission shaft, the configuration of the transmission unit is combined with the form factor of the electrical machine, thereby arriving at a compact design. At the same time, the transmission unit can be adapted to fit the requirements of an end user, such as requirements regarding number of gears and gear steps, due to the configuration thereof. Therefore, the number of constituent components needed for adapting the transmission unit to end user requirements can be minimized. In other words, the main components can be shared between central drive and electric axle configurations. This in turn leads to an increased possibility for standardization of the constituent components of the vehicle powertrain. Thus, a modular powertrain platform is provided.

In the vehicle powertrain, the first coupling device may be arranged in a first plane perpendicular to, and intersecting, a longitudinal extension (L₃) of the electrical machine. Thereby, a more compact design of the transmission unit may be achieved in view of utilizing the available space in the transmission unit alongside the electrical machine (i.e. radially outside of the electrical machine).

The first coupling device may further be configured to selectively couple the third gear wheel pair to the second shaft portion of the second transmission shaft. Thereby, there is no need for a separate coupling device to selectively couple the third gear wheel pair to the second shaft portion of the transmission shaft. This in turn reduces the number of constituent components of the transmission unit. Moreover, it may reduce the space needed in the transmission unit for accommodating coupling devices needed for effectuating desired gear changes.

The transmission unit may further comprise a fourth gear wheel pair, and the third transmission shaft may further be rotatably connectable to the first shaft portion of the second transmission shaft via said fourth gear wheel pair. Thereby, the number of gear steps may be increased, thereby arriving at a so called 3-speed transmission unit.

In the vehicle powertrain, the fourth gear wheel pair may be arranged in a second plane perpendicular to, and intersecting, a longitudinal extension of the electrical machine. Thereby, the space available in the transmission unit alongside the electrical machine, may be used for accommodating the fourth gear wheel pair. This is turn enables a more compact design of the transmission unit and thus also the vehicle powertrain.

The transmission unit may further comprise a second coupling device configured to selectively couple the second gear wheel pair to the third transmission shaft. Thereby, the transmission unit may for example be adapted for utilization in a vehicle powertrain having an electrical axle configuration and/or enabling adapting the transmission unit to a 3-speed transmission unit. By arranging the second coupling device so as to be configured to selectively couple the second gear wheel pair to the third transmission shaft, the number of possible modifications of the transmission unit to meet end user requirements is increased. Furthermore, the space in the transmission unit for accommodating constituent components may be effectively utilized, thereby enabling a more compact design of the transmission unit.

The transmission unit may further comprise a fifth gear wheel pair connecting the second shaft portion of the second transmission shaft to a drive axle of the vehicle powertrain via a differential gear of the drive axle. Thereby, the vehicle powertrain may have an electric axle configuration.

In the vehicle powertrain, the fifth gear wheel pair may be arranged in a third plane perpendicular to, and intersecting, a longitudinal extension of the electrical machine. Thereby, the available space between the second gear wheel pair and the third gear wheel pair may be efficiently used leading to a compact design of the transmission unit. This also enables arranging the electrical machine closer to a vehicle center (i.e. longitudinal center), if desired, compared to a case in which the fifth gear wheel pair would be arranged on a side of the third gear wheel pair opposite the side at which the second gear wheel pair is arranged.

Moreover, in accordance with the present disclosure, a vehicle comprising the above described vehicle powertrain is provided. The vehicle may be a fully electrical vehicle.

### BRIEF DESCRIPTION OF DRAWINGS

FIG. 1 schematically illustrates a side view of a vehicle,

FIG. 2 schematically illustrates a first exemplifying embodiment of a transmission unit in accordance with the present disclosure when arranged in a vehicle powertrain,

FIG. 3 schematically illustrates a second exemplifying embodiment of a transmission unit in accordance with the present disclosure when arranged in a vehicle powertrain,

FIG. 4 schematically illustrates a third exemplifying embodiment of a transmission unit in accordance with the present disclosure when arranged in a vehicle powertrain,

FIG. 5 schematically illustrates a cross sectional view of the transmission unit shown in FIG. 4 in plane C-C,

FIG. 6 schematically illustrates a fourth exemplifying embodiment of a transmission unit in accordance with the present disclosure when arranged in a vehicle powertrain.

### DETAILED DESCRIPTION

The invention will be described in more detail below with reference to exemplifying embodiments and the accompanying drawings. The invention is however not limited to the exemplifying embodiments discussed and/or shown in the drawings, but may be varied within the scope of the appended claims. Furthermore, the drawings shall not be considered drawn to scale as some features may be exaggerated in order to more clearly illustrate the invention or features thereof.

In accordance with the present disclosure, a transmission unit for a vehicle powertrain is provided. The transmission unit comprises a first shaft forming an input shaft of the transmission unit. The transmission unit further comprises a second transmission shaft comprising a first shaft portion and a second shaft portion. The first shaft portion is rotatably connected to the first transmission shaft via a first gear wheel pair. The transmission unit further comprises a first coupling device configured to selectively couple the first shaft portion of the second transmission shaft to the second shaft portion of the second transmission shaft. The transmission unit also comprises a third transmission shaft rotatably connectable to the first shaft portion of the second transmission shaft via a second gear wheel pair and rotatably connectable to the second shaft portion of the second transmission shaft via a third gear wheel pair. The second gear wheel pair and the third gear wheel pair are arranged at a distance from each other in a direction parallel to the longitudinal axis of the second transmission shaft such that, when the transmission unit is arranged in the vehicle powertrain, an electrical machine connected to the first transmission shaft may be arranged between the second gear wheel pair and the third gear wheel pair.

The transmission unit according to the present disclosure may, due to the arrangement of the second gear wheel pair and the third gear wheel pair, easily be adapted to end user requirements while at the same time enabling a high degree of standardization of the constituent components. This may for example be achieved by enabling to efficiently utilize the space available between the second gear wheel pair and the third gear wheel pair for accommodating possible further constituent components needed for adapting the transmission unit to end user requirements, such as number of available gear steps as well as whether the transmission unit should be utilized in a vehicle powertrain having a central drive configuration or an electric axle configuration.

The present disclosure further relates to a vehicle powertrain comprising the above described transmission unit and an electrical machine. The electrical machine acts a propulsion unit of the vehicle powertrain, and thus also a propulsion unit of a vehicle comprising the vehicle powertrain. The electrical machine may be the only propulsion unit of the vehicle powertrain. By means of the herein described transmission unit, the electrical machine may be arranged between the second gear wheel pair and the third gear wheel pair of the transmission unit, parallel to a longitudinal extension of the second transmission shaft. In other words, the second gear wheel pair and the third gear wheel pair may be arranged on opposite sides of the electrical machine as seen in a direction parallel to a longitudinal axis of the second transmission shaft.

The vehicle powertrain may be a central drive vehicle powertrain or an electric axle vehicle powertrain.

The transmission unit and the vehicle powertrain as described herein are particularly suitable for lightweight or mediumweight segment of trucks, such a distribution trucks, garbage trucks or the like. For this segment, the electrical machine can be relatively small, i.e. have a small form factor.

The transmission unit described herein may further be adapted to end user requirements in terms of desired power take-offs from the transmission unit. By way of example, a power take-off may be arranged on the first transmission shaft or on the first shaft portion of the second transmission shaft. Furthermore, it is also possible to include a retarder or other auxiliary in the vehicle powertrain. Such a retarder or other auxiliary may for example be connected to the first transmission shaft, or to the first portion of the second transmission shaft. Examples of other auxiliaries may include, but not be limited to, a water pump, a fuel pump, a steering servo pump, oil pump, compressor or the like.

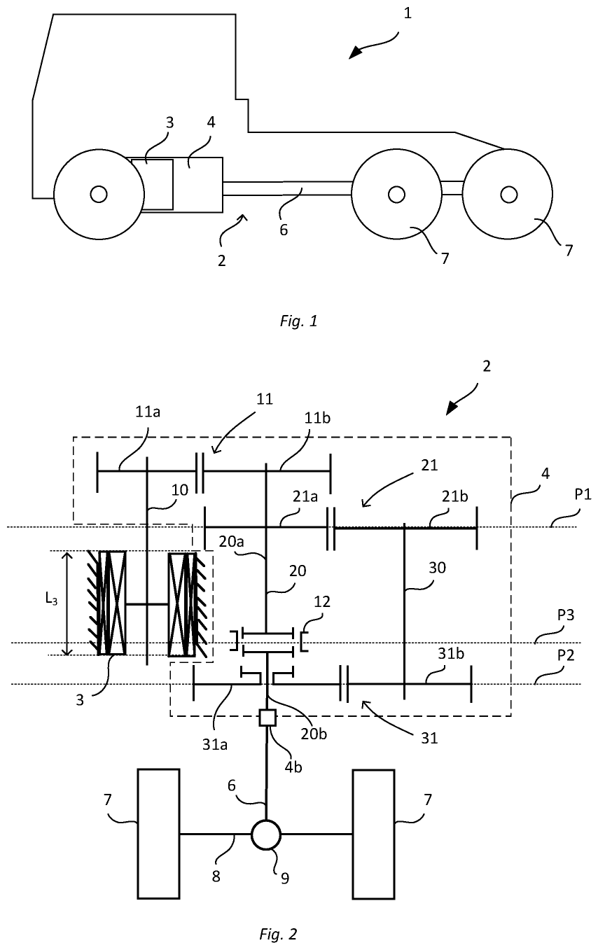

FIG. 1 schematically illustrates a side view of an example of a vehicle 1. The vehicle 1 comprises a powertrain 2 having a central drive configuration. The vehicle powertrain 2 comprises a propulsion unit in the form of an electrical machine 3, and a transmission unit 4 configured to selectively transfer driving torque to the driving wheels 7. The transmission unit 4 may be connected to the driving wheels 7 of the vehicle 1 via a propeller shaft 6. The vehicle powertrain 2 is configured to provide motive power to the vehicle 1 via the driving wheels 7. The driving wheels 7 may also be referred to as drive wheels 7.

FIG. 2 schematically illustrates a first exemplifying embodiment of a transmission unit 4 according to the present disclosure. The transmission unit 4 is in the figure illustrated as arranged in a vehicle powertrain 2, such as a vehicle powertrain of the vehicle 1 shown in FIG. 1. In addition to the transmission unit 4, the vehicle powertrain 2 comprises an electrical machine 3 configured to act as the propulsion unit. The transmission unit 4 is configured to transfer driving torque from the electrical machine 3 at different gear ratios to the driving wheels 7 via a propeller shaft 6 and a drive shaft 8. The drive shaft 8 is a wheel axle connected to the driving wheels 7. The propeller shaft 6 may be connected to the drive shaft 8 via a conventional final gear and differential 9. The propeller shaft 6, drive shaft 8, final gear and differential 9 are all constituent components of the vehicle powertrain 2, as well as the driving wheels 7. The vehicle powertrain 2 shown in FIG. 2 has a central drive configuration.

The transmission unit 4 comprises a first transmission shaft 10 to which an electrical machine 3 may be connected. The first transmission shaft 10 thus forms an input shaft of the transmission unit 4. The first transmission shaft 10 is rotatably connected to a second transmission shaft 20 of the transmission unit 4 via a first gear wheel pair 11. More specifically, the first gear wheel pair 11 comprises a first gear wheel 11a arranged on the first transmission shaft 10 and configured to rotate therewith. The first gear wheel pair 11 further comprises a second gear wheel 11b arranged on the second transmission shaft 20 and configured to rotate therewith. The cogs of the first gear wheel 11a intermesh with corresponding cogs of the second gear wheel 11b. Thus, a rotation of the first transmission shaft 10 will cause a rotation of the second transmission shaft 20 with a rotational speed proportional to the rotational speed of the first transmission shaft 10 as given by the gear ratio of the first gear wheel pair 11.

The second transmission shaft 20 is a divided shaft. In other words, the second transmission shaft 20 comprises a first shaft portion 20a and a second shaft portion 20b. The second shaft portion 20b of the second transmission shaft 20 may form an output shaft of the transmission unit 4. More specifically, the second shaft portion 20b of the second transmission shaft may comprise a connection device 4b configured to allow connection of the transmission unit 4 to a propeller shaft 6 of the vehicle powertrain 2.

The first shaft portion 20a of the second transmission shaft 20 may be connected and disconnected from the second shaft portion 20b by means of a first coupling device 12, such as an axially displaceable coupling sleeve. The first coupling device 12 is thus configured to selectively couple the first shaft portion 20a of the second transmission shaft 20 to the second shaft portion 20b of the second transmission shaft 20. When the first shaft portion 20a is coupled to the second shaft portion 20b, the first shaft portion 20a and the second shaft portion 20b of the second transmission shaft 20 are locked for rotation which each other, and will thus have the same rotational speed. The first coupling device 12 may be arranged at a position of the second transmission shaft 20 such that it will be arranged alongside the electrical machine 3, as shown in the figure, when the transmission unit is arranged in the vehicle powertrain 2. In other words, the first coupling device 12 may be arranged in a plane P3 which is perpendicular to a longitudinal extension L₃ of the electrical machine 3. The plane P3 extends through the electrical machine 3, and thus intersects the longitudinal extension L₃ of the electrical machine 3. The electrical machine 3 also has a radial extension which is perpendicular to the longitudinal extension L₃. The position of the first coupling device 12 may thus be described to be arranged radially outside of the electrical machine 3 if the first coupling device 12 is arranged alongside the electrical machine. The first coupling device 12 may comprise a dog clutch, a synchromesh or the like.

The transmission unit 4 further comprises a third transmission shaft 30. The third transmission shaft is rotatably connected to the second transmission shaft 20 by means of a second gear wheel pair 21. The second gear wheel pair 21 comprises a third gear wheel 21a connected to the second transmission shaft 20 and a fourth gear wheel 21b connected to the third transmission shaft 30.

The third transmission shaft 30 is also rotatably connectable to the second shaft portion 20b of the second transmission shaft 20 via a third gear wheel pair 31. The third wheel pair 31 comprises a fifth gear wheel 31a and a sixth gear wheel 31b. The sixth gear wheel 31b may be fixedly connected to the third transmission shaft 30 so as to rotate therewith. The fifth gear wheel 31a may be arranged on the second shaft portion 20b such that it may be rotated freely in relation to the second shaft portion 20b of the second transmission shaft, but may be selectively coupled for rotation with the second shaft portion 20b of the second transmission shaft 20. For example, the above described first coupling device 12 may be configured to selectively couple the fifth gear wheel 31a to the second shaft portion 20b of the second transmission shaft 20. This may for example be achieved by a coupling device in the form of an axially displaceable sleeve which may be axially displaceable between a first position where it couples the first shaft portion 20a to the second shaft portion 20b of the second transmission shaft 20, and a second position where the axially displaceable sleeve couples the fifth gear wheel 31a to the second shaft portion 20b of the second transmission shaft 20. Such an axially displaceable sleeve may further have a third position wherein it does not couple any constituent component to the second shaft portion 20b of the second transmission shaft 20. In such a case, the transmission unit 4 will be in neutral when the axially displaceable sleeve is in the third position.

As an alternative to the first coupling device 12 being configured to selectively couple the fifth gear wheel 31a to the second shaft portion 20b of the second transmission shaft 20, the transmission unit 4 may comprise an additional coupling device (not shown) which is configured to selectively couple the fifth gear wheel 31b to the second shaft portion 20b of the second transmission shaft 20.

When the first shaft portion 20a of the second transmission shaft 20 is coupled to the second shaft portion 20a of the second transmission shaft, and the fifth gear wheel 31a rotate freely in relation to the second transmission shaft 20, driving torque may transferred from the electrical machine 2 via the first transmission shaft 10 and the second transmission shaft 20 to the connection device 4b at a gear ratio given by the first gear wheel pair 11. Driving torque may thereafter be transmitted from the transmission unit 4 to the driving wheels 7 via the propeller shaft 6 and the drive shaft 8. However, when the first shaft portion 20a of the second transmission shaft 20 is disconnected/decoupled from the second shaft portion 20b of second transmission shaft 20 by the coupling device 12, and the fifth gear wheel 31a is locked for rotation with the second shaft portion 20b of the second transmission shaft 20, driving torque may transferred from the electrical machine 3 via the first transmission shaft 10 and the first shaft portion 20a of the second transmission shaft to the third transmission shaft 30 and thereafter to the second shaft portion 20b of the second transmission shaft 20. In the latter case, driving torque may thus be transmitted from the electrical machine 3 to the connection device 4b and the propeller shaft 6 at a ratio given by the first gear wheel pair 11, the second gear wheel pair 21 and the third gear wheel pair 31. The transmission unit 4 according to the first exemplifying embodiment is thus a so called 2-speed transmission unit.

As shown in the figure, the second gear wheel pair 21 and the third gear wheel pair 31 are arranged at a distance from each other in a direction parallel to a longitudinal axis of the second transmission shaft 20 such that, when the transmission unit 4 is arranged in the vehicle powertrain 2, the electrical machine 3 may be arranged between the second gear wheel pair 21 and the third gear wheel pair 31. Described differently, a first plane P1, comprising the centers of rotation of the gear wheels of the second gear wheel pair, and a second plane P2, parallel with the first plane P1 and comprising the centers of rotation of the gear wheels of the third gear wheel plane, are arranged at a distance from each other such that the electrical machine 3 may be arranged therebetween. The planes P1 and P2 are each perpendicular to the longitudinal axis of the second transmission shaft 20. In other words, the second gear wheel pair 21 and the third gear wheel pair 31 may be arranged on opposite sides of the electrical machine 3 as seen in a direction parallel to a longitudinal axis of the second transmission shaft 20. This also means that the planes P1 and P2 do not traverse the longitudinal extension L₃ of the electrical machine 3, and the whole electrical machine 3, including its rotor and its stator, may be arranged between the planes P1 and P2. The planes P1 and P2 are however perpendicular to a central axis of the electrical machine 3. Thereby, the electrical machine 3 may be arranged closer to the second transmission shaft. This in turn enables the electrical machine to be closer to a longitudinal center of the vehicle powertrain 2. The longitudinal center of the vehicle powertrain shown in FIG. 2 coincides with the longitudinal axis of the second transmission shaft 20 and the propeller shaft 6.

Albeit not shown in FIG. 2, the transmission unit 4 may further comprise one or more power take off connection devices, as desired. Such power take off connection devices may for example be arranged on the first transmission shaft 10 at the end opposite the end connectable to the electrical machine 3, and/or on the first shaft portion 20a of the second transmission shaft 20 at the longitudinal end thereof opposite to the connection device 4b. The vehicle powertrain 2 shown in FIG. 2 may further comprise a retarder or other auxiliary (not shown), if desired. Such a retarder or other auxiliary may for example be arranged on the first transmission shaft 10 at the end opposite the end connectable to the electrical machine 3. Alternatively, a retarder or other auxiliary may be arranged on the side of the electrical machine 3 opposite to where it is connected to the transmission unit 4.

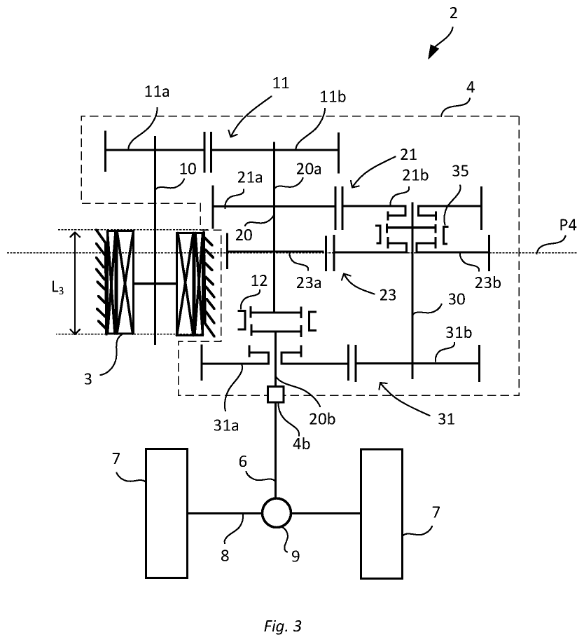

FIG. 3 schematically illustrates a second exemplifying embodiment of a transmission unit 4 according to the present disclosure when arranged in a vehicle powertrain 2 having a central drive configuration. The transmission unit 4 according to the second exemplifying embodiment is similar to the transmission unit 4 according to the first exemplifying embodiment described with reference to FIG. 2. However, the transmission unit 4 according to the second exemplifying embodiment further comprises a second coupling device 35 and a fourth gear wheel pair 23.

The second coupling device 35 is configured to selectively couple the first shaft portion 20a of the second transmission shaft 20 to the third transmission shaft 30 by means of second gear wheel pair 21. More specifically, the second coupling device 35 is configured to selectively couple the fourth gear wheel 21b to the third transmission shaft 30. In other words, the fourth gear wheel 21b of the second gear wheel pair 21 is in the second exemplifying embodiment of the transmission unit 4 arranged on the third transmission shaft 30 such that it may rotate freely in relation to the third transmission shaft 30, but may also be locked for rotation with the third transmission shaft 30 by the second coupling device 35.

The fourth gear wheel pair 23 comprises a seventh gear wheel 23a and an eighth gear wheel 23b. The seventh gear wheel 23a is fixedly arranged on the first shaft portion 20a of the second transmission shaft 20, and thus configured to rotate with the first shaft portion 20a. The eighth gear wheel 23b is arranged on the third transmission shaft 30 such that it may rotate freely in relation to the third transmission shaft 30, but may be selectively coupled for rotation with the third transmission shaft 30. As shown in the figure, the eighth gear wheel 23b may be selectively coupled to the third transmission shaft by means of the second coupling device 35. This may for example be achieved, by the second coupling device 35 comprising an axially displaceable sleeve which may be axially displaced between two or three positions in the corresponding manner as described above with regard to the first coupling device 12. It is however also possible to utilize a separate coupling device for the purpose of enabling coupling the eighth gear wheel 23b to the third transmission shaft for rotation therewith.

As shown in FIG. 3, the fourth gear wheel pair 23 may be arranged between the second gear wheel pair 21 and the third gear wheel pair 31. More specifically, the fourth gear wheel pair 23 may be arranged at a position along the longitudinal axis of the second transmission shaft 20 such that, when the transmission unit 4 is arranged in the vehicle powertrain 2, the fourth gear wheel pair 23 is arranged alongside the electrical machine 3, which in turn is connected to the first transmission shaft 10. In other words, the fourth gear wheel pair 23 may thus be arranged in a plane P4 which is perpendicular to the longitudinal extension L₃ of the electrical machine 3. The plane P4 extends through the electrical machine 3, and thus intersects the longitudinal extension L₃ of the electrical machine 3. The plane P4 is parallel to the planes P1, P2 and P3 mentioned above. Thereby, the vehicle powertrain 2 may have a compact design. Alternatively, the fourth gear wheel pair 23 may be interposed between the first gear wheel pair 11 and the second gear wheel pair 21, if desired.

In the same way as described with regard to the transmission unit according to the first exemplifying embodiment shown in FIG. 2, driving torque may be transmitted by the transmission unit 4 according to the second exemplifying embodiment shown in FIG. 3 from the electrical machine 3 to the propeller shaft 6 via only the first transmission shaft 10 and the second transmission shaft 20 when the first shaft portion 20a and the second shaft portion 20b are coupled to each other and the fifth gear wheel 31a rotate freely in relation to the second transmission shaft. In other words, the third transmission shaft 30 does not transfer any driving torque from the electrical machine to the propeller shaft when the first shaft portion 20a is coupled to the second shaft portion 20b of the second transmission shaft. However, when the first shaft portion 20a of the second transmission shaft 20 is disconnected/decoupled from the second shaft portion 20b of second transmission shaft 20, and the fifth gear wheel 31a is locked for rotation with the second shaft portion 20b of the second transmission shaft 20, driving torque may transferred from the electrical machine 3 via the first transmission shaft 10 and the first shaft portion 20a of the second transmission shaft 20 to the third transmission shaft 30 and thereafter to the second shaft portion 20b of the second transmission shaft 20. The first shaft portion 20a may in such a case be connected to the third transmission shaft either by the second gear wheel pair 21 or the fourth gear wheel pair 23, the alternatives providing different gear ratios. The transmission unit 4 according to the second exemplifying embodiment is thus a so called 3-speed transmission unit.

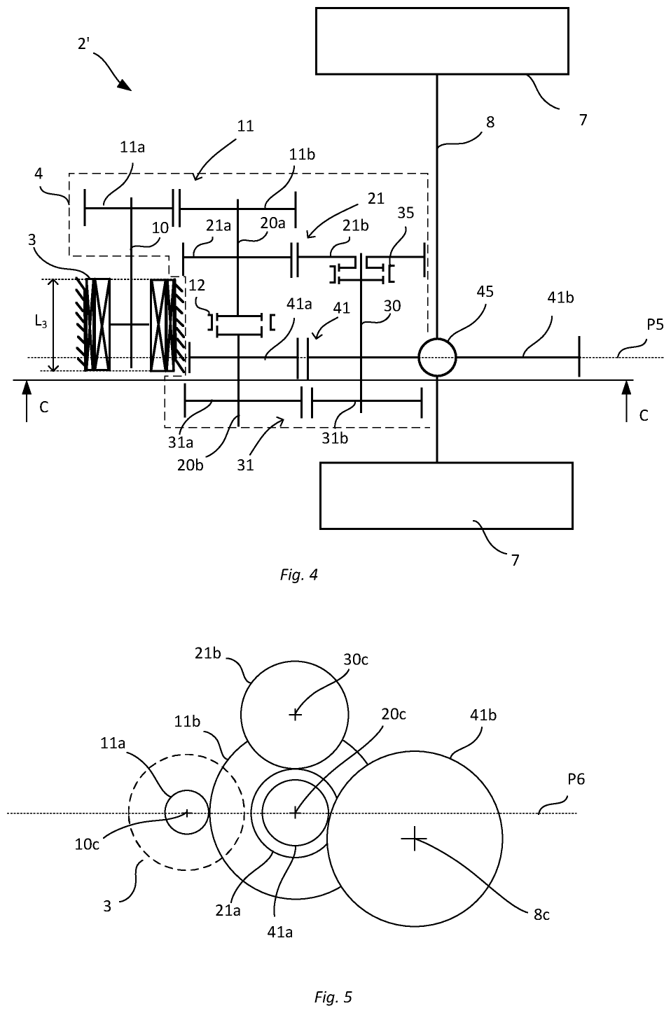

FIG. 4 schematically illustrates a third exemplifying embodiment of a transmission unit 4 according to the present disclosure when arranged in a vehicle powertrain 2′. In contrast to the vehicle powertrains 2 shown in FIGS. 2 and 3, respectively, the vehicle powertrain 2′ shown in FIG. 4 has an electric axle configuration.

The transmission unit 4 according to the third exemplifying embodiment is similar to the transmission unit according to the first exemplifying embodiment described above, but further comprises a second coupling device 35 and a fifth gear wheel pair 41. The second coupling device 35 may be configured to selectively couple the second gear wheel pair 21 to the third transmission shaft as shown in the figure. As an alternative, the second coupling device 35 may according to the third exemplifying embodiment instead be associated with the sixth gear wheel 31b and thereby be configured to selectively couple the third transmission shaft 30 to the second shaft portion 20b of the second transmission shaft via the third gear wheel pair 31. According to yet an alternative, the second coupling device 35 may be associated with the fifth gear wheel 31a and thereby be configured to selectively couple the third transmission shaft 30 to the second shaft portion 20b of the second transmission shaft 20 via the third gear wheel pair 31.

The fifth gear wheel pair 41 is configured to rotatably connect the second shaft portion 20b of the second transmission shaft 20 to the drive shaft 8 of the vehicle powertrain 2. The drive shaft 8 is a wheel axle connected to the driving wheels 7. The fifth gear wheel pair 41 comprises a ninth gear wheel 41a and a tenth gear wheel 41b. The ninth gear wheel 41a is fixedly arranged on the second shaft portion 20b of the second transmission shaft 20, and is thus configured to rotate therewith. The tenth gear wheel 41b is, via a differential 45, connected to the drive shaft 8. Thus, driving torque may be transferred from the second shaft portion 20b of the transmission unit 4 to the drive shaft 8 via the fifth gear wheel pair 41 and the differential 45. In contrast to a vehicle powertrain having a central drive configuration, there is no propeller shaft arranged between the second shaft portion of the second transmission shaft and the differential, but the tenth gear wheel 41b is directly connected to the differential 45.

As shown in the figure, the fifth gear wheel pair 41 may be arranged between the second gear wheel pair 21 and the third gear wheel pair 31, as seen in a direction parallel with the longitudinal extension of the second transmission shaft 20. Thereby, a compact design of the transmission unit 4 may be achieved. The fifth gear wheel pair 41 may thereby be arranged in the space available alongside the electrical machine 3 when the transmission unit 4 is arranged in the vehicle powertrain 2′. In other words, the fifth gear wheel pair 41 may be arranged in a plane P5 perpendicular to the longitudinal extension of the electrical machine 3. The plane P5 extends through the electrical machine 3, and thus intersects the longitudinal extension L₃ of the electrical machine 3. This also enables the electrical machine to be arranged closer to the longitudinal central axis of a vehicle comprising the vehicle powertrain 2′, if desired. As evident from the figure, also the differential center of the differential 45 may be arranged in a plane perpendicular to the longitudinal extension L₃ of the electrical machine when the transmission unit 4 is arranged in the vehicle powertrain 2′.

When the first shaft portion 20a of the second transmission shaft 20 is coupled to the second shaft portion 20a of the second transmission shaft 20, and the third transmission shaft 30 is able to rotate freely in relation to the second transmission shaft, driving torque may be transferred from the electrical machine 3 via the first transmission shaft to the second transmission shaft by means of the first gear wheel pair 11. Thereafter, the driving torque is may be transferred from the second shaft portion 20b of the second transmission shaft 20, via the fifth gear wheel pair 41, to the differential and the drive shaft 8 and thereby to the driving wheels 7. However, when the first shaft portion 20a is decoupled from the second shaft portion 20b and the third transmission shaft 30 is rotatably connected to the first shaft portion 20a and the second shaft portion 20b, driving torque may be transmitted from the first transmission shaft 10 to the first shaft portion 20a of the second transmission shaft 20 via the first gear wheel pair 11, and thereafter from the first shaft portion 20a to the third transmission shaft 30 via the second gear wheel pair 21 and further to the second shaft portion 20b of the second transmission shaft 20 via the third gear wheel pair 31. From the second shaft portion 20b of the second transmission shaft, driving torque may then be transferred to the drive shaft 8 via the fifth gear wheel pair 41 and the differential 45.

In order to further clarify the transmission unit 4 according to the third exemplifying embodiment, FIG. 5 schematically illustrates a cross sectional view of the transmission unit 4 illustrated in FIG. 4 as seen in plane C-C of FIG. 4. For ease of illustration, the gear wheels are illustrated as circles, i.e. the cogs of the gear wheels are not shown. It should however be noted that gear wheels of a respective gear wheel pair cooperated with each other by the cogs thereof intermeshing with each other. Moreover, the various shafts are merely illustrated by showing their respective central axes, i.e. their axes of rotation. Furthermore, albeit not being a part of the transmission unit per se, the arrangement of an electrical machine 3 connected to the transmission unit 4 is illustrated by dashed lines. The electrical machine 3 is however not fully drawn in FIG. 5 since the first gear wheel 11a in such a case would not be visible in the cross sectional view according to plane C-C of FIG. 4. Furthermore, the differential 45 has been omitted in the figure for not being a part of the transmission unit 4 per se, and sake of clarity.

As shown in FIG. 5, the first gear wheel 11a is rotatably arranged around a central axis 10c of the first transmission shaft and is cooperating with the second gear wheel 11b. The second gear wheel 11b is rotatably arranged around the central axis 20c of the second transmission shaft. Furthermore, the third gear wheel 21a is rotatably arranged around the central axis 20c and is cooperating with the fourth gear wheel 21b, which in turn is rotatably arranged around a central axis 30c of the third transmission shaft 30. Moreover, the ninth gear wheel is rotatably arranged around the central axis 20c of the second transmission shaft and is cooperating with the tenth gear wheel 41b, which in turn is rotatably arranged around the central axis 8c of the drive shaft 8.

The central axis 10c of the first transmission shaft 10 and the central axis 20c of the second transmission shaft 20 may be arranged in a common plane P6. The central axis 30c of the third transmission shaft 30 may however be offset from the common plane P6. Moreover, the central axis 8c of the drive shaft 8 may be offset from the common plane P6. More specifically, the central axis 30c of the third transmission shaft 30 and the central axis 8c (which also is the rotational axis of the tenth gear wheel 41b) may be arranged on opposite sides of a plane P6 comprising the central axis 10c of the first shaft 10 and the central axis 20c of the second transmission shaft 20.

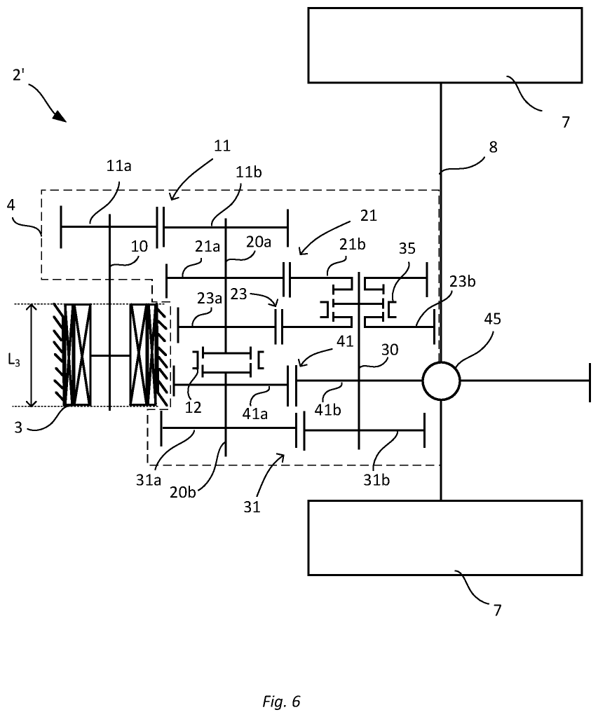

FIG. 6 schematically illustrates a fourth exemplifying embodiment of a transmission unit 4 according to the present disclosure, when arranged in a vehicle powertrain 2′ having an electric axle configuration. The fourth exemplifying embodiment is similar to the transmission unit according to the second exemplifying embodiment described above and illustrated in FIG. 3, but further comprises a fifth gear wheel pair 41. The fifth gear wheel pair 41 is configured to connect the second shaft portion 20b of the second transmission shaft 20 with the drive axle 8 via the differential 45.

The fifth gear wheel pair 41 may be arranged between the third gear wheel pair 31 and the fourth gear wheel pair as seen in a direction parallel with the extension of the second transmission shaft. Thereby, the space available alongside the electrical machine may be efficiently utilized and the transmission unit may have a compact design.

It can also be noted that the fourth exemplifying embodiment illustrated in FIG. 6 is similar to the third exemplifying embodiment described above, and illustrated in FIG. 4, but differs therefrom in that it also comprises the fourth gear wheel pair 23. Thereby, the transmission unit 4 according to the fourth exemplifying embodiment is a so called 3-speed transmission unit.

Irrespective of the exemplifying embodiment of the transmission unit described herein, it can be noted that the first, second and third transmission shafts are parallelly arranged in the transmission unit. Similarly, the gear wheel pairs of the transmission unit are arranged in planes which are parallel to each other. A gear wheel pair is considered to be arranged in a plane in which both centers of rotation of the two gear wheels of a gear wheel pair is arranged.

As shown in the FIGS. 2 and 3, the transmission unit 4 according to the present disclosure may in case of being utilized in a vehicle powertrain having a central drive configuration be arranged such that the second transmission shaft 20 has a longitudinal extension which is substantially perpendicular to the longitudinal extension of the drive shaft 8. In case the transmission unit 4 according to the present disclosure being utilized in a vehicle powertrain having an electric axle configuration, the transmission unit may however be arranged such that the second transmission shaft 20 has a longitudinal extension which is substantially parallel with the longitudinal extension of the drive shaft 8.

1. A transmission unit for a vehicle powertrain, the transmission unit comprising:
a first transmission shaft forming an input shaft of the transmission unit;
a second transmission shaft comprising a first shaft portion and a second shaft portion, the first shaft portion being rotatably connected to the first transmission shaft via a first gear wheel pair;
a first coupling device configured to selectively couple the first shaft portion of the second transmission shaft to the second shaft portion of the second transmission shaft; and
a third transmission shaft rotatably connectable to the first shaft portion of the second transmission shaft via a second gear wheel pair and rotatably connectable to the second shaft portion of the second transmission shaft via a third gear wheel pair;
wherein the second gearwheel pair and the third gear wheel pair are arranged at a distance from each other in a direction parallel to a longitudinal axis of the second transmission shaft such that, when the transmission unit is arranged in the vehicle powertrain, an electrical machine connected to the first transmission shaft may be arranged between the second gear wheel pair and the third gear wheel pair.

2. The transmission unit according to claim 1, wherein the first coupling device is arranged at a position along the longitudinal axis of the second transmission shaft such that, when the transmission unit is arranged in the vehicle powertrain, the first coupling device is located in a first plane perpendicular to, and intersecting, a longitudinal extension of an electrical machine connected to the first transmission shaft.

3. The transmission unit according to claim 1, wherein the first coupling device further is configured to selectively couple the third gear wheel pair to the second shaft portion of the second transmission shaft.

4. The transmission unit according to claim 1, further comprising a fourth gear wheel pair, and wherein the third transmission shaft further is rotatably connectable to the first shaft portion of the second transmission shaft via the fourth gear wheel pair.

5. The transmission unit according to claim 4, wherein the fourth gear wheel pair is arranged at a position along the longitudinal axis of the second transmission shaft such that, when the transmission unit is arranged in the vehicle powertrain, the fourth gear wheel pair is located in a second plane perpendicular to, and intersecting, a longitudinal extension of an electrical machine connected to the first transmission shaft.

6. The transmission unit according to claim 1, further comprising a second coupling device configured to selectively couple the second gear wheel pair to the third transmission shaft.

7. The transmission unit according to claim 1, further comprising a fifth gear wheel pair configured to rotatably connect the second shaft portion of the second transmission shaft a drive shaft of the vehicle powertrain, via a differential gear of the drive shaft, when the transmission unit is arranged in the vehicle powertrain.

8. The transmission unit according to claim 7, wherein the fifth gear wheel pair is arranged between the second gear wheel pair and the third gear wheel pair.

9. A vehicle powertrain comprising a transmission unit and an electrical machine connected to an input shaft of the transmission unit;
the transmission unit comprising:
a first transmission shaft forming the input shaft of the transmission unit;
a second transmission shaft comprising a first shaft portion and a second shaft portion, the first shaft portion being rotatably connected to the first transmission shaft via a first gear wheel pair;
a first coupling device configured to selectively couple the first shaft portion of the second transmission shaft to the second shaft portion of the second transmission shaft; and
a third transmission shaft rotatably connectable to the first shaft portion of the second transmission shaft via a second gear wheel pair and rotatably connectable to the second shaft portion of the second transmission shaft via a third gear wheel pair;
wherein the electrical machine is arranged parallel to a longitudinal extension of the second transmission shaft, and
the second gear wheel pair and the third gear wheel pair are arranged on opposite sides of the electrical machine as seen in a direction parallel to a longitudinal axis of the second transmission shaft.

10. The vehicle powertrain according to claim 9, wherein the first coupling device of the transmission unit is arranged in a first plane perpendicular to, and intersecting, a longitudinal extension of the electrical machine.

11. The vehicle powertrain according to claim 9, wherein the first coupling device further is configured to selectively couple the third gear wheel pair to the second shaft portion of the second transmission shaft.

12. The vehicle powertrain according to claim 9, wherein the transmission unit further comprises a fourth gear wheel pair, and wherein the third transmission shaft further is rotatably connectable to the first shaft portion of the second transmission shaft via the fourth gear wheel pair.

13. The vehicle powertrain according to claim 12, wherein the fourth gear wheel pair is arranged in a second plane perpendicular to, and intersecting, a longitudinal extension of the electrical machine.

14. The vehicle powertrain according to claim 9, wherein the transmission unit further comprises a second coupling device, the second coupling device configured to selectively couple the second gear wheel pair to the third transmission shaft.

15. The vehicle powertrain according to claim 9, wherein the transmission unit further comprises a fifth gear wheel pair connecting the second shaft portion of the second transmission shaft to a drive axle of the vehicle powertrain via a differential gear of the drive axle.

16. The vehicle powertrain according to claim 15, wherein the fifth gear wheel pair is arranged in a third plane perpendicular to, and intersecting, a longitudinal extension of the electrical machine.

17. A vehicle comprising the vehicle powertrain according to claim 9.
